(19) United States
(12) Patent Application Publication
(10) Pub. No.: US 2004/0036791 A1
(43) Pub. Date: Feb. 26, 2004

(54) Disposable digital electronic devices having detachable and powered liquid crystal display

(76) Inventors: James S. Voss, Fort Collins, CO (US); James W. Owens, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/226,533

(22) Filed: Aug. 23, 2002

(51) Int. Cl. H04N 5/222

(52) U.S. Cl. 348/333.07

(57) ABSTRACT

Disclosed are portable electronic devices, including disposable digital photographic still cameras and portable camcorders, that have detachable and reusable liquid crystal displays. One portable electronic device comprises a removable liquid crystal display having a generic docking connector. Another portable electronic device comprises an integrated liquid crystal display and battery unit that is detachable and reusable. Yet another portable electronic device comprises a detachable and reusable tethered liquid crystal display having a pigtail connector.

### BACKGROUND

The present invention relates generally to digital cameras, and more specifically, to disposable and reusable portable electronic devices, such as digital cameras and camcorders, that employ detachable, reusable and powered liquid crystal displays.

The assignee of the present invention manufactures digital cameras and other computer-related products. Currently available disposable digital cameras are entirely disposable and have a simple optical lens-type viewfinder.

In order to provide for a digital camera that has “instant review” features, which allow a user to look at the photographs that have been recorded, a liquid crystal display is typically used. However, conventional liquid crystal displays are permanently attached to the camera. Furthermore, a liquid crystal display is an expensive component that is generally restricted to a single product, and as such is permanently attached.

European Patent Application No. 1102479 A1 discloses a “throwaway digital camera suited to a recycling system. The throwaway digital camera (1) includes a unit substrate (8), on which are mounted expensive parts, including a CCD device (83a) as imaging means, RAM (83b) as storage means, infrared emitting/receiving photodiodes (86c, 86d) as data transfer means, and CPU (83e) and ROM (83f) as control means. The unit substrate (8) and a power supply battery (9) for supplying power to all the means described above are housed in a container (2) from which they can be collected separately. Expensive parts can be easily collected by removing the unit substrate (8) separately from the battery (9) as a source of environmental pollution.”

However, European Patent Application No. 1102479 A1 is concerned with controlling environmental pollution by disposing or recycling these components, and does not disclose or suggest the use of a dockable, reusable liquid crystal display that is used in multiple digital cameras and that is reused by a user of the camera. The liquid crystal display disclosed in European Patent Application No. 1102479 A1 is mounted to a substrate along with other expensive components and is not separately removable or reusable by itself.

U.S. Pat. No. 6,287,028 discloses a “recyclable, one-time use, print on demand, digital camera comprises a housing. A chassis is contained within the housing. An image sensor device, supported on said chassis, senses an image. A processor, arranged in the housing, processes the image sensed by the image sensor device. A replenishable supply of print media is supported on the chassis. The supply of print media includes a former defining a chamber and a quantity of print media carried by the former. A pagewidth print head is arranged on the chassis for printing, on demand, the sensed image on the print media as the print media traces the print head. A power supply is arranged within the former of the supply of print media for providing power to the image sensor device, the processing means, the print head and a drive means for the supply of print media.” However, nothing is disclosed or suggested in U.S. Pat. No. 6,287,028 regarding a digital camera employing a detachable liquid crystal panel.

LCD's are notorious for consuming power in battery operated devices. Prior art electronic devices employing liquid crystal displays use large expensive batteries, and there is no currently available solution that allows a consumer buying a device to “remove” the expensive LCD's for other uses.

Journalists and consumers at large public events are often obscured from getting a shot or video of a scene because they are located at the back of a large crowed. It is believed that no one has yet built a remotely displayed LCD attached to a digital camera or digital camcorder.

A search relating to the present invention was performed in the US Patent and Trademark Office and uncovered the following U.S. patents: U.S. Pat. No. 6,084,555, U.S. Pat. No. 5,233,502, U.S. Pat. No. 4,977,456, U.S. Pat. No. 5,965,848, U.S. Pat. No. 4,796,977, U.S. Pat. No. 5,662,402, U.S. Pat. No. 5,715,136, U.S. Pat. No. 6,160,666, U.S. Pat. No. 5,659,361, and US Patent Application Publication No. 2002/0054212.

U.S. Pat. No. 6,084,555 discloses a “Spectacle type display device”, where “In order to facilitate pupil distance adjustment, diopter adjustment and convergence adjustment, in a spectacle type display arrangement which utilizes of a pair of image generating units for projecting images on left and right eyes respectively, a pair of shafts are installed in a housing by way of a frame, and a pair of lens and mirror units are reciprocally mounted on the shafts so as to movable toward and away from each other. A slide plate which forms part of a backlight is disposed on the frame so as to be slid able in the fore-and-aft direction. A pair of shafts are disposed one above the other at the upper and lower portions of the backlight. A pair of LCD holders which form a part of the pair of image source means are supported on the shafts so as to be laterally movable toward and away from each other. A pupil distance adjustment of the pair of image generating means is implemented by a rotation of a knob 8 through cam and link mechanisms, while a diopter adjustment and a convergence adjustment are simultaneously implemented by a rotation of a knob through a separate cam mechanism.” However, nothing is disclosed or suggested in U.S. Pat. No. 6,084,555 regarding a camera, a digital camera or a detachable liquid crystal panel for use with a digital camera.

U.S. Pat. No. 5,233,502 discloses a “Removable and reversible display device for portable computer” that “relates to a portable, note-book, hand held or clam shell type of computer operable in multiple configurations. A modular, removable, and reversible display device with a touch screen feature is provided. With the display device disposed in a first configuration, the computer is operable in a first or open housing configuration. With the display device disposed in a second configuration, the computer is operable in a second or closed housing configuration.” However, nothing is disclosed or suggested in U.S. Pat. No. 5,233,502 regarding a camera, a digital camera or a detachable liquid crystal panel for use with a digital camera.

U.S. Pat. No. 4,977,456 discloses an “electronic viewfinder for displaying video images captured in an attached electronic camera utilizes a liquid crystal display which can be illuminated from the rear by ambient illumination or by light from an included fluorescent lamp. The liquid crystal display is positioned at a slight angle to the viewer's line of sight and light transmitted by the display is diffused thereafter to provide a high quality image.” It is stated in U.S. Pat. No. 4,977,456 that “Liquid crystal assembly 2 is connected by means of a detachable connector 3 to main electric circuit assembly 4, thus facilitating dis-assembly, assembly, and/or replacement during servicing.” Thus, while the liquid crystal assembly is detachable, it is designed to be detached during servicing. It is not designed to be removed from the camera by a user and then reinstalled in another camera by the user.

U.S. Pat. No. 5,965,848 discloses a “disposable portable electronic device has a body of prescribed length and thickness and constructed of an elongate, ribbon-like substrate of dielectric material, the substrate having a continuous length much greater than the length of the body, and a thickness much less than the thickness of the body, with conductors and components formed on the substrate, the dielectric material of the substrate having a high degree of flexibility such that the substrate is folded upon itself into at least shorter lengths juxtaposed with one another within the thickness of the body, and the juxtaposed lengths of the substrate are secured together to establish a self-sustaining structure which forms the body of the device.” However, nothing is disclosed or suggested in U.S. Pat. No. 5,965,848 regarding a camera, a digital camera or a detachable liquid crystal panel for use with a digital camera.

U.S. Pat. No. 4,796,977 discloses a “unitary holder for removably mounting and electrically connecting to a visually perceptible display including integral locating and retention means for the display.” However, nothing is disclosed or suggested in U.S. Pat. No. 4,796,977 regarding a camera, a digital camera or a detachable liquid crystal panel for use with a digital camera.

U.S. Pat. No. 5,662,402 discloses a “Projector with detachable liquid crystal panel.” However, nothing is disclosed or suggested in U.S. Pat. No. 5,662,402 regarding a camera, a digital camera or a detachable liquid crystal panel for use with a digital camera.

U.S. Pat. No. 5,715,136 discloses a “removable/adjustable digital display accessory (10) for computers (60) for displaying a digital readout indicative of the current operating speed of the processor incorporated in a personal computer (60). The accessory (10) is designed for being removably secured to the cover (64) of a personal computer case (62) within an otherwise unused drive slot (66) defined by the cover (64). The accessory (10) is adapted to be installed in lieu of a cover plate (68) in the cover (64). The accessory (10) includes a base plate (12) and at least a digital display unit (26) having a digital display (28). The digital display unit (26) is provided for indicating the current processor speed and is carried on the back of the base plate (12). A turbo indicator (34) and a hard disk drive indicator (36) are also carried by the base plate (12). The accessory (10) may also be provided with a date and time clock (38) for continual display of the date and time. A plurality of signal strength indicators (40) may also be provided for indicating the strength of the electrical signal being delivered to a like number of components such as the hard disk drive, the RAM, the processor, a printer, and an auxiliary device. Further, the accessory (10) may be provided with a reset switch (44) and a turbo switch (46). A face plate (48) is secured to the base plate (12) in a conventional manner to cover each of the digital display unit (26) and turbo and hard disk drive indicators (34,36). A securement device (54) is provided for securing the accessory (10) to the cover (64) of the computer (60).” However, nothing is disclosed or suggested in U.S. Pat. No. 5,715,136 regarding a camera, a digital camera or a detachable liquid crystal panel for use with a digital camera.

U.S. Pat. No. 6,160,666 discloses a “visual display device is provided for delivering a generated image, preferably combinable with environment light, to the eye of a user. The device is lightweight and compact but yields a high quality image. In one embodiment, a color shutter provides a high-density color image. In one embodiment, a shroud protects from stray light and holds optical elements in desired alignment. In one embodiment an image generator is masked by at least two masks to provide for a high quality image without waste. In one embodiment, a removably mounted shield or activatable device can convert the apparatus from a see-through device to an immersion device and back again. In one embodiment, the device can be comfortably mounted to the user's head while still allowing for use of conventional eyeglasses. In one embodiment various controls, such as a mute button, volume control and the like can be provided, such as by mounting on the head-mounted display device.” However, nothing is disclosed or suggested in U.S. Pat. No. 6,160,666 regarding a camera, a digital camera or a detachable liquid crystal panel for use with a digital camera.

U.S. Pat. No. 5,659,361 discloses a “tiltable, rotatable and detachable LCD view finder for a camcorder that enables a user to easily take pictures while viewing the LCD viewfinder. The viewfinder can be rotated 360.degree and tilted 180.degree relative to the upper surface of the camcorder body. The viewfinder system includes: an LCD (Liquid Crystal Display) viewfinder; a downwardly opened recess formed on a predetermined edge portion of said LCD viewfinder and having a first side wall, a second side wall, a back wall and a semicircular end; and a tiltable, rotatable and detachable compound joint assembly member fitted into said recess for tiltably, rotatably and detachably connecting the LCD viewfinder, whereby the LCD viewfinder can be tilted, rotated, and detached relative to the camcorder body.” However, nothing is disclosed or suggested in U.S. Pat. No. 5,659,361 regarding a disposable digital photographic camera or a detachable liquid crystal panel for use with a disposable digital photographic camera.

US Patent Application Publication No. 2002/0054212 discloses a “digital electronic camera which can accept various types of input/output cards or memory cards. When an I/O card is inserted into and connected with the camera, a processor within the camera determines the type of I/O card which has been connected by reading a memory location within the card. A control program which is contained in the I/O card is transferred to a memory within the camera in order for the camera to perform I/O functions which correspond to the type of the inserted card. Different types of I/O cards which may be used include a modem card, a LAN card, a SCSI card, or an ISDN interface. Image signals and audio signals are transmitted between the camera and an external processor, information describing the status of the camera is transmitted from the camera to the external processor, and commands to control the camera are transmitted to the camera from the external processor.” It is stated in US Patent Application Publication No. 2002/0054212 that “The LCD panel 31 including the speaker 32 is not required to operate the camera and are easily detachable from the camera in order to reduce the size and weight of the camera, if desired.” However, nothing is disclosed or suggested in US Patent Application Publication No. 2002/0054212 regarding a disposable digital photographic camera having a detachable liquid crystal panel that is detachable and reusable on a replacement disposable digital photographic camera.

It would be desirable to have a reusable liquid crystal display with a generic docking connector that may be used in a variety of devices, including a disposable digital camera, for example, where everything except the liquid crystal display is sent in for prints and service.

Accordingly, it is an objective of the present invention to provide for disposable and reusable portable electronic devices, such as digital cameras and camcorders, that employ detachable, reusable and powered liquid crystal displays.

### SUMMARY OF THE INVENTION

To accomplish the above and other objectives, the present invention provides for portable electronic devices, including disposable digital photographic still cameras and portable camcorders, that have detachable and reusable liquid crystal displays. A first embodiment of the digital camera comprises a removable liquid crystal display having a generic docking connector. A second embodiment of the digital camera comprises an integrated liquid crystal display and battery unit that is detachable and reusable. A third embodiment of the digital camera comprises a detachable and reusable tethered liquid crystal display having a pigtail connector.

In the first embodiment, the removable liquid crystal display comprising the generic docking connector may be used in a variety of devices, including a disposable digital still photographic camera, for example, where all components except the liquid crystal display are sent to a processing center for prints, service and remanufacture. The LCD is one of the most expensive components in a digital camera. Since the LCD is removable by the user, it can be kept by the user when prints are required. In these cases, the camera body without the LCD can be mailed in or transferred for printing services, at which time the device is serviced, repackaged and sold again, much like traditional disposable cameras.

In the second embodiment, the unit is constructed using the available area of the LCD, applying a mechanical isolation material to the back side of the LCD, and then enclosing a chemical battery within a single housing including the LCD. The area of the LCD times the thickness of the overall housing behind the LCD determines the total volume available for the chemical battery. This allow the unit to store approximately the same amount of battery chemicals found in today's standard AA or larger batteries, depending upon the thickness of the volume available for the chemical battery. The battery is preferably a rechargeable type such as Ni-Cad, LiIon, or Ni-Metal-Hydride battery.

In the third embodiment, using a standard connectivity protocol (e.g., Firewire, universal serial bus (USB), serial, or Bluetooth, for example), and which may be a wired or wireless connectivity protocol, a display is coupled to a video camcorder or digital still camera. The LCD requires an additional controller or ASIC that handles the wired or wireless connectivity protocol that interfaces it to the digital still camera or video camcorder.

LCD's are notorious for consuming power in battery operated devices. The first embodiment of the present invention is designed to solve several problems. Because the LCD is removable for times when it is not needed, this reduces the amount of power that is consumed. In the second embodiment of the present invention, by providing an LCD with its own additional power source, when it is attached to the portable electronic device, there will be additional power available for powering the LCD and other components. Furthermore, the third embodiment of the present invention allows a person to lift the camera or camcorder above a crowed to take a photograph while allowing the person to see what the camera is seeing so that an accurate photograph is taken.

### BRIEF DESCRIPTION OF THE DRAWINGS

The various features and advantages of the present invention may be more readily understood with reference to the following detailed description taken in conjunction with the accompanying drawing, wherein like reference numerals designate like structural elements, and in which:

FIG. 1 is a rear view of an exemplary digital camera employing exemplary embodiments of a detachable liquid crystal display in accordance with the principles of the present invention;

FIG. 2 is a rear view of the digital camera with the exemplary embodiments of the detachable liquid crystal display removed from the camera;

FIG. 3 is a front view of the exemplary digital camera shown in FIGS. 1 and 2;

FIG. 4 is a rear view of the exemplary embodiments of the detachable liquid crystal display;

FIG. 5 is a bottom view of the detachable liquid crystal display illustrating two exemplary embodiments thereof; and

FIG. 6 is a rear view of an exemplary digital camera employing a second exemplary embodiment of a detachable liquid crystal display in accordance with the principles of the present invention.

### DETAILED DESCRIPTION

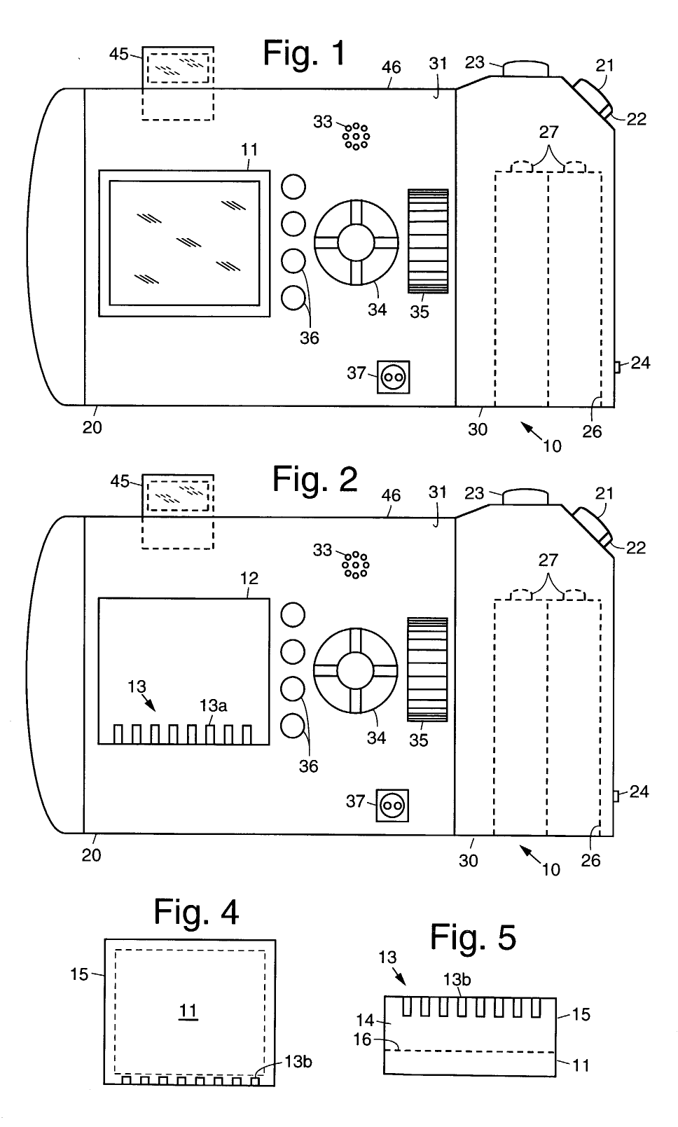

Referring to the drawing figures, FIG. 1 is a rear view of a portable electronic device comprising an exemplary digital camera 10 employing exemplary embodiments of a detachable liquid crystal display 11 in accordance with the principles of the present invention. The exemplary digital camera 10 comprises a handgrip section 20 and a body section 30. The handgrip section 20 includes a power button 21 having a lock latch 22, a shutter button 23, a strap connection 24, and a battery compartment 26 for housing batteries 27.

A rear surface 31 of the body section 30 comprises a detachable (removable) liquid crystal display (LCD) 11 in accordance with the principles of the present invention, a rear microphone 33, a joystick pad 34, a zoom control dial 35, a plurality of buttons 36 for setting functions of the camera 10 and an output port 37 for downloading images to a computer, for example. A pop-up flash device 45 is disposed on an upper surface 46 of the camera 10.

As is shown in FIG. 2, a cavity 12 is provided into which the detachable (removable) liquid crystal display 11 is housed. A connector 13 comprising a plurality of contacts 13a is disposed at the bottom and back of the cavity 12. The contacts 13a of the connector 13 engage contacts 13b (FIG. 4) disposed on the detachable (removable) liquid crystal display 11 when it is inserted into the cavity.

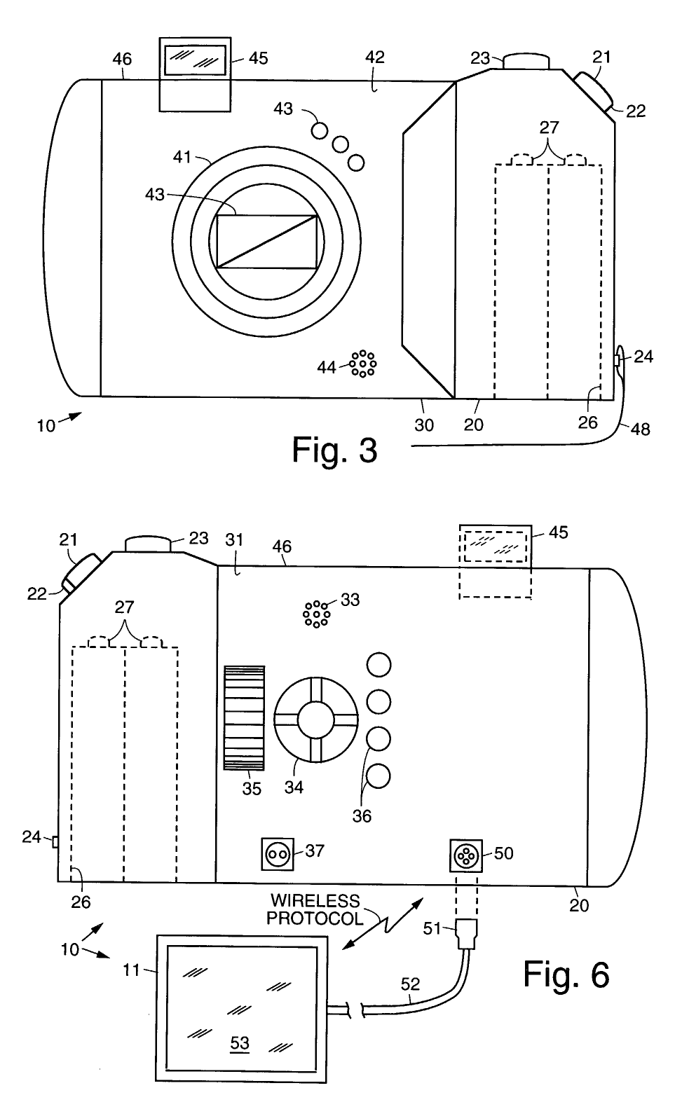

Referring to FIG. 3, it is a front view of the exemplary digital camera 10. As is shown in FIG. 3, a zoom lens 41 extends from the front surface 42 of the camera 10. A shutter 43 is disposed within the body section 30 that is visible behind the lens 41. One or more metering elements 43 are disposed on the front surface 42 of the camera 10. A front microphone 44 is disposed on the front surface 42 of the camera 10. A strap 48 is shown connected to the strap connection 24.

Referring to FIG. 4, it shows a rear view of the exemplary embodiments of the detachable liquid crystal display 11. The detachable liquid crystal display 11 has a housing 15 comprising a plurality of contacts 13b that are configured to engage the plurality of contacts 13a of the connector disposed in the cavity 12 of the camera 10.

FIG. 5 shows a bottom view of the detachable liquid crystal display 11 and illustrates two exemplary embodiments thereof. In a first embodiment, the detachable liquid crystal display 11 includes just the plurality of contacts 13a. In a second embodiment, the detachable liquid crystal display 11 has a housing 15 that houses the liquid crystal display 11, and includes the plurality of contacts 13a.

The housing 15 is larger than the liquid crystal display 11 and provides a space or cavity in which a chemical battery 14 is disposed. A mechanical isolation material 16 is disposed between the liquid crystal display 11 and the chemical battery 14 to separate them and protect the liquid crystal display 11. The chemical battery 14 is used to power the liquid crystal display 11 and other components of the camera 10 in addition to the conventional batteries 27 disposed in the handgrip 30.

FIG. 6 is a rear view of an exemplary digital camera 10 employing a second exemplary embodiment of a detachable liquid crystal display 11 in accordance with the principles of the present invention. In the exemplary digital camera 10 shown in FIG. 6, the detachable liquid crystal display 11 comprises a tethered liquid crystal display having a cable 52 coupled to a pigtail connector 51. The pigtail connector 51 is configured to mate with a connector 50 disposed on the back side 31 of the camera 10, for example.

The liquid crystal display 11 also includes an additional controller 53 or application specific integrated circuit (ASIC) 53 that processes display signals using a selected communication protocol that interfaces it to the digital still camera 10. A standard connectivity or communication protocol such as Firewire, universal serial bus (USB), serial, or Bluetooth, for example, is used to interface the detachable liquid crystal display 11 to electronics in the camera 10. It is also to be understood that the third embodiment of the detachable liquid crystal display 11 employing the pigtail connector 51 may be readily employed with a camcorder, for example.

In the first embodiment, the removable liquid crystal display 11 comprising the generic docking connector 13 may be used in a variety of devices, including a disposable digital still photographic camera 10, for example, where all components except the liquid crystal display 11 are sent to a processing center for prints, service and remanufacture. Since the liquid crystal display 11 is relatively expensive, and is removable by a user, it can be kept by the user when prints are required. Thus, the camera 10 without the liquid crystal display 11 can be mailed in or transferred for printing services, at which time the device is serviced, repackaged and sold again, much like traditional disposable cameras.

In the second embodiment, the housing 15 encloses the liquid crystal display 11, the mechanical isolation material on the back side of the liquid crystal display 11, and the chemical battery 14. The area of the LCD times the thickness of the overall housing behind the liquid crystal display 11 determines the total volume available for the chemical battery 14. This version of the liquid crystal display 11 can store approximately the same amount of battery chemicals found in today's standard AA or larger batteries, depending upon the thickness of the volume available for the chemical battery 14. The chemical battery 14 used in this embodiment of the liquid crystal display 11 is preferably a rechargeable type such as Ni-Cad, LiIon, or Ni-Metal-Hydride battery.

In the third embodiment, the standard connectivity protocol (e.g., Firewire, USB, serial, or Bluetooth, for example), is used to couple the liquid crystal display 11 to a video camcorder or digital still camera 10. The liquid crystal display 11 includes an additional controller 53 or ASIC 53 that handles the protocol to interface to the digital still camera 10 or camcorder. Furthermore, the connectivity or communication protocol may be a wired or wireless connectivity protocol. Thus, the liquid crystal display 11 is not necessarily tethered, but may be wirelessly coupled to the digital still camera 10.

Liquid crystal displays 11 consume a great deal of power in battery operated devices. The first embodiment of the present invention solves several problems. Because the liquid crystal display 11 is removable at times when it is not needed, this reduces the amount of power that is consumed. In the second embodiment of the present invention, by providing a liquid crystal display 11 with its own additional power source, when it is attached to the portable electronic device (digital camera 10 or camcorder), there will be additional power available for powering the liquid crystal display 11 and other components. The third embodiment of the present invention allows a person to lift the camera 10 or camcorder above a crowd to take a photograph or video while allowing the person to see what the camera 10 is seeing so that an accurate photograph is taken.

Thus, portable electronic devices, such as digital photographic still cameras and camcorders, having detachable, reusable and powered liquid crystal displays have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A portable electronic device comprising:
a body section; and
a detachable liquid crystal display detachably coupled to the body section.

2. The device recited in claim 1 wherein the detachable liquid crystal display is disposed in a detachable housing that comprises a chemical battery.

3. The device recited in claim 2 wherein liquid crystal display is separated from the chemical battery by mechanical isolation material.

4. The device recited in claim 1 wherein the body section comprises a cavity having connector contacts disposed therein and into which the detachable liquid crystal display may be disposed, and wherein the detachable liquid crystal display comprises mating connector contacts that are configured to mate with the connector contacts in the cavity.

5. The device recited in claim 1 wherein the body section comprises a connector disposed on an exterior surface, and wherein the detachable liquid crystal display comprises a pigtail connector that is configured to mate with the connector of the body section, and further comprises a controller that implements a predetermined communication protocol to communicate between the liquid crystal display and electronics in the body section.

6. The device recited in claim 5 wherein the predetermined communication protocol comprises a Firewire communication protocol.

7. The device recited in claim 5 wherein the predetermined communication protocol comprises a universal serial bus (USB) communication protocol.

8. The device recited in claim 5 wherein the predetermined communication protocol comprises a serial communication protocol.

9. The device recited in claim 5 wherein the predetermined communication protocol comprises a Bluetooth communication protocol.

10. The device recited in claim 1 wherein the portable electronic device comprises a digital photographic still camera.

11. The device recited in claim 1 wherein the portable electronic device comprises a digital camcorder.

12. The device recited in claim 1 wherein the body section comprises:
a rear surface comprising a cavity for receiving the detachable liquid crystal display, a microphone, a joystick pad, one or more buttons for setting functions of the camera, and an output port;
a lens extending from a front surface;
a shutter disposed behind the lens;
a metering element disposed on the front surface;
a pop-up flash device at an upper surface of the body section; and
a handgrip section that comprises a power button, a shutter button, and a battery compartment for housing batteries.

13. The device recited in claim 4 wherein the body section further comprises:
a rear surface comprising a cavity for receiving the detachable liquid crystal display, a microphone, a joystick pad, one or more buttons for setting functions of the camera, and an output port;
a lens extending from a front surface;
a shutter disposed behind the lens;
a metering element disposed on the front surface;
a pop-up flash device at an upper surface of the body section; and
a handgrip section that comprises a power button, a shutter button, and a battery compartment for housing batteries.

14. The device recited in claim 5 wherein the body section further comprises:
a rear surface comprising a cavity for receiving the detachable liquid crystal display, a microphone, a joystick pad, one or more buttons for setting functions of the camera, and an output port;
a lens extending from a front surface;
a shutter disposed behind the lens;
a metering element disposed on the front surface;
a pop-up flash device at an upper surface of the body section; and
a handgrip section that comprises a power button, a shutter button, and a battery compartment for housing batteries.

15. The device recited in claim 1 wherein the detachable liquid crystal display is detachably coupled to the body section using a wired communication protocol.

16. The device recited in claim 1 wherein the detachable liquid crystal display is detachably coupled to the body section using a wireless communication protocol.
